(19) United States
(12) Patent Application Publication
(10) Pub. No.: US 2002/0032781 A1
(43) Pub. Date: Mar. 14, 2002

(54) Intermediary server apparatus and an information providing method

(75) Inventors: Hideki Yoshida, Kanagawa-ken (JP); Tetsuro Muranaga, Kanagawa-ken (JP); Go Fujino, Tokyo (JP); Seiji Maeda, Kanagawa-ken (JP); Yasuhiro Kimura, Kanagawa-ken (JP); Kiyoko Sato, Kanagawa-ken (JP); Hirokuni Yano, Kanagawa-ken (JP); Junichi Segawa, Kanagawa-ken (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Minato-ku (JP)

(21) Appl. No.: 09/946,360

(22) Filed: Sep. 6, 2001

(30) Foreign Application Priority Data
Sep. 12, 2000 (JP) 2000-277114

(51) Int. Cl. G06F 15/16

(52) U.S. Cl. 709/228; 709/203; 709/246

(57) ABSTRACT

An intermediary server apparatus relays an information readout request from a terminal to an origin server, and returns information provided by the origin server to the terminal. The intermediary server apparatus previously assigns a first user ID to a user to discriminate each user. The origin server assigns a second user ID to the user to identify the information readout request. In the intermediary server apparatus, a memory correspondingly stores the first user ID and the second user ID. A communication unit retrieves the second user ID corresponding to the first user ID from said memory in case of receiving the information readout request including the first user ID from the terminal, and sends the information readout request including the second user ID to the origin server.

### CROSS-REFERENCE TO RELATED APPLICATIONS

This application is based upon and claims the benefit of priority from the prior Japanese Patent Application PH2000-277114, filed on Sep. 12, 2000; the entire contents of which are incorporated herein by reference.

### FIELD OF THE INVENTION

The present invention relates to an intermediary server apparatus and an information providing method for effectively providing data to a user through a network even if the user changes terminals.

### BACKGROUND OF THE INVENTION

An information providing system on a network such as the World-Wide Web (WWW) is often utilized by a computer such as a work station or a personal computer. Accordingly, in general, a user uses his predetermined terminal, and seldom uses a plurality of terminals. However, recently, the Internet is accessed by various devices such as a cellular-phone and a portable information terminal, and one user often uses a plurality of terminals. For example, in the information providing system, a history function automatically records which information is referred by the user. In the history, URL (Uniform Resource Locator: Identifier of information) of referred information is recorded in a terminal. Accordingly, if the user changes from one terminal to another terminal, the URL of the referred information is not utilized again. In this case, the user must directly input the URL through another terminal or must find the URL by tracing a link of information on a display of another terminal. This operation is very troublesome for the user.

Furthermore, originally, a WWW server cannot identify the user of a communication client. Access to the WWW server from the user's terminal is cut by unit of one time. At the WWW server side, a plurality of accesses (requests) from the same user cannot be treated as one continuous access. Accordingly, a technique to relate the plurality of requests from the same user is necessary. For example, by using a “cookie”, a user ID is stored in the user's terminal. When the terminal connects to the WWW server again, the terminal sends the cookie to the WWW server. In this case, the WWW server can specify the user of the terminal by the cookie (the user ID), and can continue a session to the terminal. However, if the user changes the terminal to another terminal, the WWW server cannot identify the user by the cookie, and cannot continue the session.

Furthermore, information provided by the WWW server is often created on the assumption that the information is displayed on a predetermined terminal (Hereinafter, the information is called “Web page”.). For example, if the terminal requests information readout for the WWW server, the terminal informs a terminal type name, a software name and a version by a header “User-Agent” defined by HTTP (Hypertext Transfer Protocol). In this case, the WWW server selects appropriate URL by recognizing these data, and informs the URL to the terminal. The terminal sends an information readout request using the URL for the WWW server again. However, the URL corresponds to Web page created for a predetermined type of terminal. Accordingly, even if the URL is sent to the WWW server, information corresponding to the URL cannot be displayed on another type of terminal.

On the other hand, in WWW network, an intermediary server often exists between the terminal and the WWW server in order to relay communication. As the intermediary server, a proxy server and a surrogate server are selectively utilized. Hereinafter, these servers are explained.

The proxy server is located near the terminal on the network, and mediates the communication between the terminal and the WWW server. In this case, security improves by access control, and data caching reduces network load. In case of using the proxy server, the WWW server is discriminatingly called an origin server.

The surrogate server (Internet Web Replication and Caching Taxonomy, I Cooper, I Me 1ve, and G. Tomlinson, Internet-Draft, Jun. 23, 2000 draft-ietf-wrec-taxonomy-04.txt) looks like the WWW server from the terminal side. However, actually, the origin server exists behind the surrogate server. The surrogate server sends information as a representative of the origin server in response to a request from the terminal. A replication server and a reverse proxy server are examples of the surrogate server. In order to realize the surrogate server, the same mechanism of the proxy server is utilized. In case of receiving a data request from the terminal, the surrogate server can relay the data request from the proxy server to the origin server. However, the origin server can send the data to the surrogate server in advance without waiting for the request from the terminal.

The proxy server is located near the terminal and controlled by a user or at a service provider side. On the other hand, the surrogate server is controlled by a contents provider operating the origin server. In short, the proxy server and the surrogate server are controlled differently and are technically different. However, an aspect such as relay between the terminal and the origin server (WWW server) is common to the proxy server and the surrogate server. Hereinafter, these servers are called “an intermediary server”.

As mentioned-above, in order for the WWW server to continuously execute the session to the user who accesses repeatedly, a cookie to specify the terminal and an access history to access the WWW server accessed by the terminal in the past are utilized. However, the cookie and the access history are stored in the terminal. Accordingly, if the user changes the terminal to another terminal, they cannot be utilized.

Furthermore, even if one user utilizes a plurality of terminals, a terminal attribute such as a type of CPU and a version of browser is often different for each terminal. Accordingly, when the user changes from one terminal to another terminal and accesses the same Web page through another terminal, the user cannot easily access using the URL because of different terminal attributes.

### BRIEF SUMMARY OF THE INVENTION

It is an object of the present invention to provide an intermediary server apparatus and an information providing method at the origin server side to identify one user even if the one user accesses the origin server through a plurality of terminals.

According to an aspect of the present invention, there is provided an intermediary server apparatus which relays an information readout request from a terminal to an origin server, and relays information provided by the origin server to the terminal, comprising: a memory configured to correspondingly store a first user ID to discriminate each user and a second user ID to discriminate each information readout request, the second user ID being assigned by the origin server to the user to identify the information readout request; a communication unit configured to retrieve the second user ID in response to the first user ID from said memory in case of receiving the information readout request including the first user ID from the terminal, and to send the information readout request including the second user ID to the origin server.

Further in accordance with another aspect of the present invention, there is also provided an information providing method for relaying an information readout request from a terminal to an origin server, and for relaying information provided by the origin server to the terminal, comprising: correspondingly storing a first user ID to discriminate each user and a second user ID to discriminate each information readout request in a memory, the second user ID being assigned by the origin server to the user to identify the information readout request; retrieving the second user ID in response to the first user ID from the memory in case of receiving the information readout request including the first user ID from the terminal; and sending the information readout request including the second user ID to the origin server.

Further in accordance with another aspect of the present invention, there is also provided a computer program product, comprising: a computer readable program code embodied in said product for causing a computer to relay an information readout request from a terminal to an origin server, and to relay information provided by the origin server to the terminal, said computer readable program code having: a first program code to correspondingly store a first user ID to discriminate each user and a second user ID to discriminate each information readout request in a memory, the second user ID being assigned by the origin server to the user to identify the information readout request; a second program code to retrieve the second user ID in response to the first user ID from the memory in case of receiving the information readout request including the first user ID from the terminal; and a third program code to send the information readout request including the second user ID to the origin server.

### BRIEF DESCRIPTION OF THE DRAWINGS

FIG. 1 is a block diagram of a WWW system according to various embodiments of the present invention.

FIG. 2 is a block diagram of the intermediary server apparatus according to various embodiments of the present invention.

FIG. 3 is one example of memory content of a session information memory according to various embodiments of the present invention.

FIG. 4 is one example of memory content of a history memory according to various embodiments of the present invention.

FIG. 5 is one example of memory content of a correspondence relation memory according to various embodiments of the present invention.

FIG. 6 is one example of format of an information readout request.

FIG. 7 is one part of a flow chart of information provision processing of the intermediary server apparatus according to the first embodiment of the present invention.

FIG. 8 is the other part of a flow chart of information provision processing of the intermediary server apparatus according to the first embodiment of the present invention.

FIG. 9 is one example of updated memory content of the correspondence relation memory according to various embodiments of the present invention.

FIG. 10 is one example of updated memory content of the session information memory according to various embodiments of the present invention.

FIG. 11 is one example of updated memory content of the history memory according to various embodiments of the present invention.

FIG. 12 is a flow chart of history presentation processing of the intermediary server apparatus according to the first embodiment of the present invention.

FIG. 13 is a flow chart of information readout processing of the intermediary server apparatus according to a second embodiment of the present invention.

FIG. 14 is one example of memory content of the session information memory according to the second embodiment of the present invention.

### DETAILED DESCRIPTION OF THE INVENTION

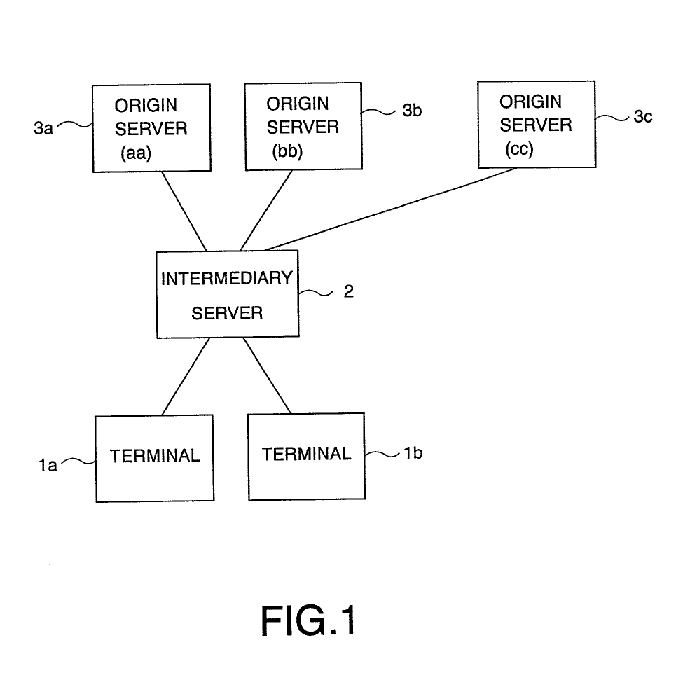

Hereinafter, various embodiments of the present invention will be explained by referring to the drawings. FIG. 1 is a block diagram of a WWW system according to embodiments of the present invention. In FIG. 1, the WWW system includes a plurality of WWW servers 3a, 3b, 3c (In this case, three) as the origin server, a plurality of terminals 1a, 1b (In this case, two) for one user to access to the origin server, and an intermediary server 2 as the proxy server or the surrogate server for the WWW servers 3a, 3b, 3c. Hereafter, the WWW servers 3a, 3b, 3c are called the origin server. In FIG. 1, two terminals 1a, 1b commonly connecting to the intermediary server 2 are shown. However, the number of terminals is arbitrarily selected. Furthermore, three origin servers 3a, 3b, 3c commonly connecting to the intermediary server 2 are shown. However, the number of origin servers is arbitrarily selected. For example, in case that the intermediary server is the proxy server, the number of origin servers is more than one.

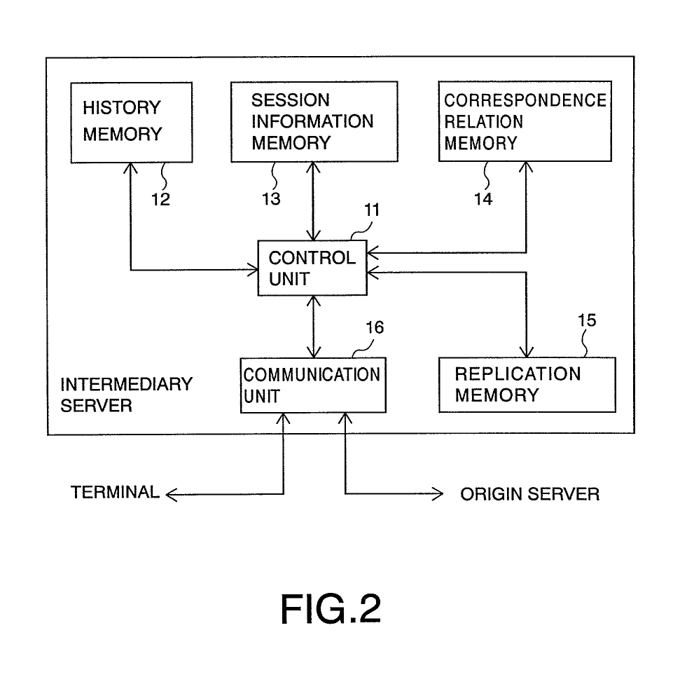

FIG. 2 is a block diagram of the intermediary server 2 according to a first embodiment of the present invention. In FIG. 2, the intermediary server 2 includes a control unit 11, a history memory 12, a session information memory 13, a correspondence relation memory 14, a replication memory 15, and a communication unit 16. The intermediary server 2 previously assigns a user ID (first user ID) to each user. The user ID is referred to by the intermediary server 2 in order to discriminate each user. On the other hand, the origin server 3a, 3b, 3c respectively assigns a server-side user ID (second user ID) to a user when an information readout request is first received from a terminal by the user. The intermediary server 2 correspondingly manages the user ID and the server-side user ID.

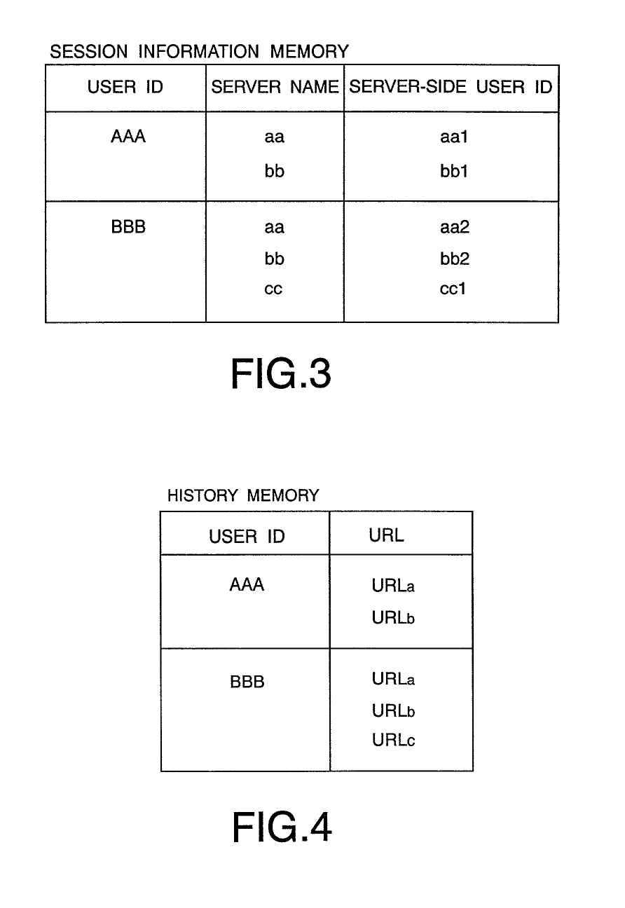

FIG. 3 is one example of memory content of the session information memory 13. As shown in FIG. 3, the user ID for the intermediary server to discriminate each user, a server name (host name) of the origin server accessed through the terminal by the user, and the server-side user ID for the origin server to discriminate each user are correspondingly stored. The server-side user ID is stored as a cookie. For example, the origin server 3a, 3b, 3c corresponds the session to the server-side user ID as the cookie, and provides a personal service for the user discriminated by the server-side user ID. As shown in FIG. 3, a user of the user ID “AAA” accesses the origin server 3a (server name “aa”) and the origin server 3b (server name “bb”) in order to refer the information (For example, Web page). In this case, the origin server 3a assigns the server-side user ID “aa1” to the user, and the origin server 3b assigns the server-side user ID “bb1” to the user.

FIG. 4 is one example of memory content of the history memory 12. The history memory stores a history representing which user referred to which information (For example, Web page). As shown in FIG. 4, the user ID and URL of information referred to by a user of the user ID are correspondingly stored.

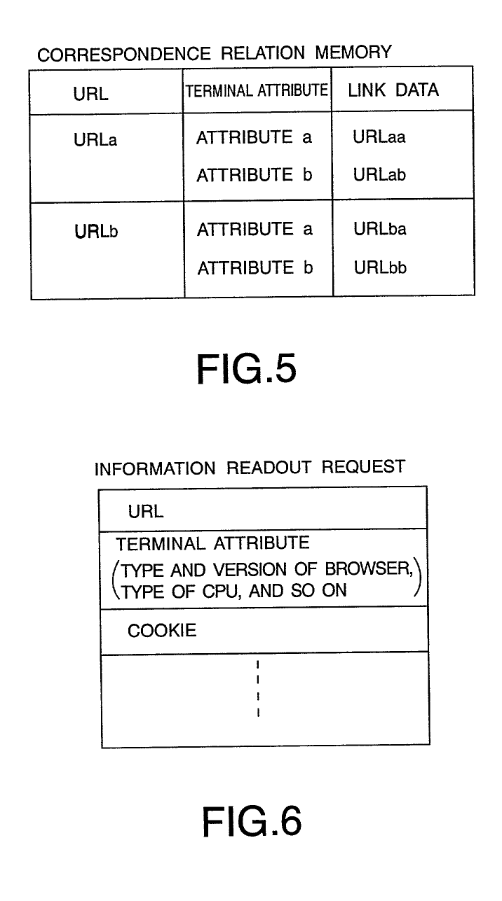

FIG. 5 is one example of memory content of the correspondence relation memory 14. In general, if terminal attributes (For example, type of CPU, type and version of browser) are different, the URL to access the same contents from the terminal is different. In the correspondence relation memory 14, URL of representative terminal attribute and URL of different terminal attribute are correspondingly stored by unit of the same contents. As shown in FIG. 5, as for the contents indicated by “URLa”, URL is “URLaa” in case of the terminal attribute “a”, and URL is “URLab” in case of the terminal attribute “b”.

The replication memory 15 stores information (For example, Web page) sent by the origin server 3a, 3b, 3c. For example, the information is stored at a predetermined period. If a readout request of the information is not received at least one time, this information may be deleted. Conversely, if information as object of the readout request is stored in the replication memory 15, this information is read from the replication memory 15, and provided to the information requesting terminal.

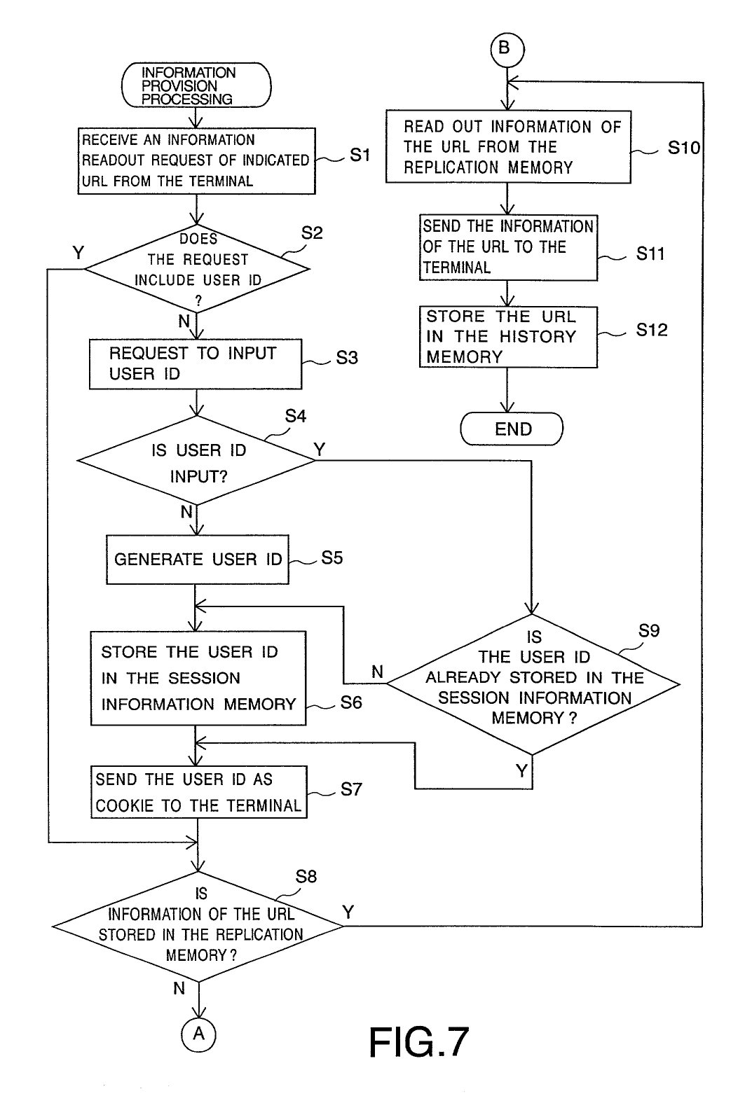

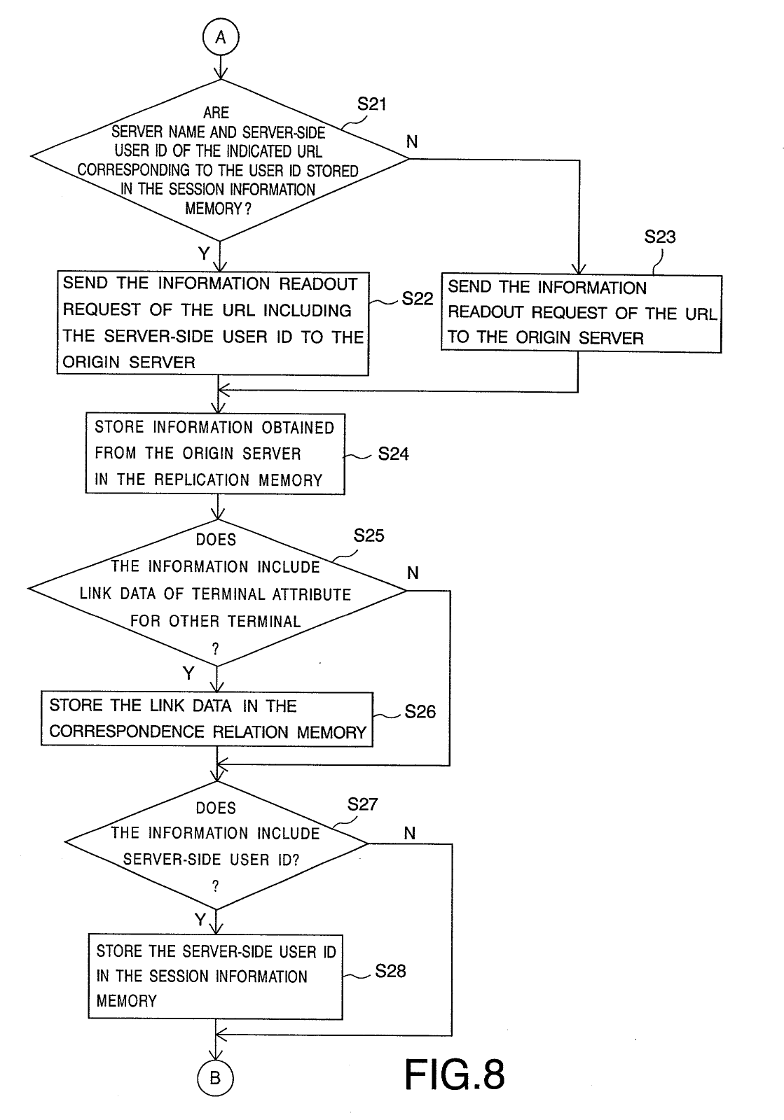

Next, by referring to flow charts shown in FIGS. 7 and 8, processing of the intermediary server 2 is explained. First, a user specifies his desired URL using one of a plurality of terminals, and accesses a WWW server in order to read out information. For example, the user accesses a desired WWW server using a terminal 1a located at home. After viewing the Web page, the user accesses the same WWW server using a portable terminal 1b. The user connects the portable terminal 1b to the Internet and indicates the URL with desired information. The portable terminal 1b sends an information readout request to the intermediary server 2. The control unit 11 in the intermediary server 11 receives the information readout request of indicated URL from the terminal 1b through the communication unit 16 (S1). As shown in FIG. 6, this information readout request includes a URL to indicate WWW server which provides information, a terminal attribute of the terminal 1b of request source, and a cookie (including the user ID) stored in the terminal 1b. If the cookie is not stored in the terminal 1b, the cookie is not included in the information readout request. As the terminal attribute, type of the terminal 1b (For example, type of CPU, type and version of browser) is described. If the request includes the user ID as a cookie format (S2), the control unit 11 utilizes it in processing from S8. If the request does not include the user ID (S2), the control unit 11 requests the user to input the user ID (S3). In response to this request, the user inputs the user ID from the terminal 1b. This user ID is the same as the one used for the terminal 1a.

When the intermediary server 2 receives the user ID from the terminal 1a (S4), the control unit 11 decides whether this user ID is already stored in the session information memory 13 (S9). If it is stored, the processing is forwarded to S7. If it is not stored, the processing is forwarded to S6. If the user ID is not input at S4, the control unit 11 newly generates a user ID for the user (S5), and the processing is forwarded to S6. If the user ID is not included in the information readout request, the user ID is not stored in the information requesting terminal (In this example, the user ID is not stored in the terminal 1b). This means that the user has not previously accessed the intermediary server using the terminal 1b. The control unit 11 generates a new user ID at S5 the first time the user accesses the intermediary server 2. If the user ID is newly generated at S5 or if the user ID input by the user is not stored in the session information memory 13 at S4, the control unit 11 stores the user ID in the session information memory 13 (S6). Furthermore, the control unit 11 sends the user ID in a cookie to the terminal 1b (S7). This cookie is preserved in the terminal 1b.

For example, it is assumed that the intermediary server 2 receives the information readout request including “URLc” only from the terminal 1b. In this case, a user ID as the cookie format is not included in the information readout request. Accordingly, the control unit 11 requests the user to input a user ID, and receives the user ID “AAA” from the user. As shown in FIG. 3, the user ID “AAA” is already stored in the session information memory 13 (S9). The control unit 11 sends the user ID “AAA” as the cookie to the terminal 1b.

Next, in response to the information readout request, the control unit 7 retrieves information corresponding to URL included in the request from the replication memory 15. If the information indicated by the URL is retrieved from the replication memory 15, the processing is forwarded to S10.

If the information indicated by the URL is not stored in the replication memory 9, the control unit 11 checks whether a server name described in the URL and a server-side user ID are stored in correspondence with the user ID in the session information memory 13. If the server name and the server-side user ID are already stored in the session information memory 13, the control unit 11 replaces the user ID of the cookie by the server-side user ID in the information readout request. Furthermore, if the user ID is not included in the information readout request received from the terminal 1b, the control unit 11 includes the server-side user ID as a cookie in the information readout request. In both cases, the control unit 11 sends the information readout request to corresponding original server (S21). If the server name and the server-side user ID are not stored in the session information memory 13, the control unit 11 sends the information readout request not including the server-side user ID to the corresponding origin server (S23).

For example, in above-mentioned example, it is assumed that the user ID is “AAA” and URL in the information readout request is “URLc”. As shown in FIG. 3, the session information memory 13 does not store a server name described in “URLc” and a server-side user ID in correspondence with the user ID “AAA” (S21). In this case, the information readout request from the terminal 1b is transferred to a corresponding origin server (In FIG. 1, the origin server 3c whose server name is “cc”) as it is (S23). When the origin server 3c receives the information readout request, the origin server 3c reads out information corresponding to “URLc”, and sends the information to the intermediary server 2. In this case, if the information readout request includes the server-side user ID as a cookie, which is already assigned by the origin server 3c, the origin server 3c executes processing using the cookie in the same way as prior art. If the information readout request does not include the server-side user ID assigned by the origin server 3c, the origin server 3c newly generates a server-side user ID (For example, “cc2”), and sends the server-side user ID with the information to the intermediary server 2.

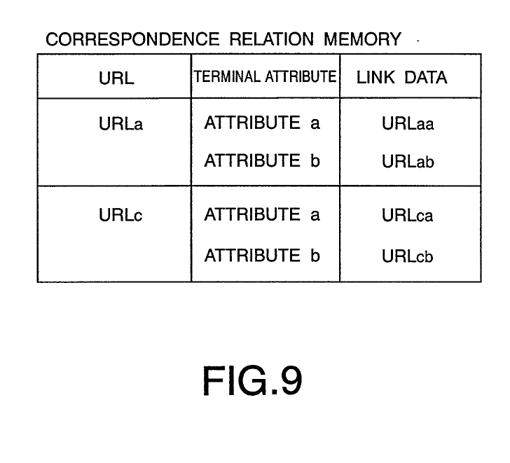

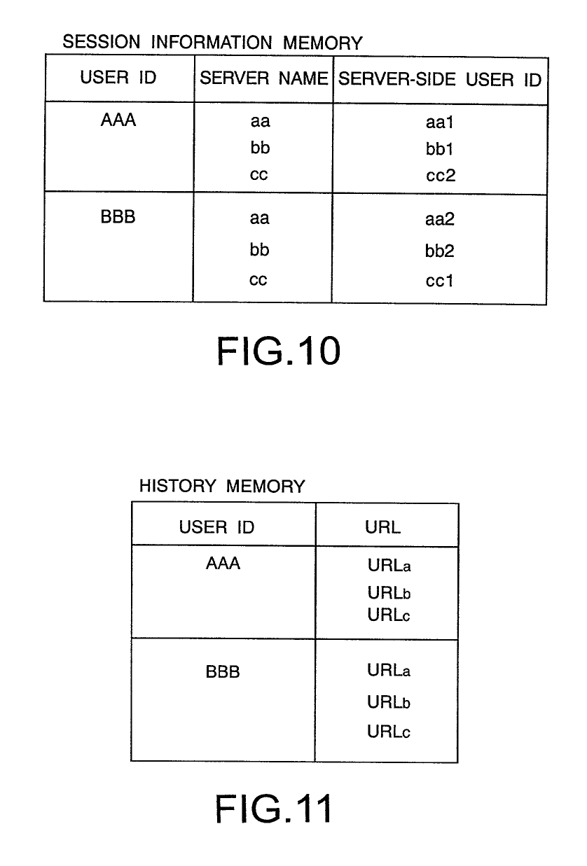

If the URL of the information for terminal attributes other than the terminal 1b exists, the origin server 3c additionally sends the URL to the intermediary server 2. This URL is called “link data” for the information. In the intermediary server 2, the information sent by the origin server 3c is stored in the reproduction memory 15 (S24). Furthermore, if a URL for other terminal attributes is received (S25), that URL is stored in the correspondence relation memory 14 as the link data (S26). For example, it is assumed that the origin server 3c sends the link data “URLca” for the terminal attribute “a” and the link data “URLcb” for the terminal attribute “b” as different URLs. In this case, as shown in FIG. 9, these link data for each terminal attribute are stored in correspondence with “URLc” in the correspondence relation memory 14. Furthermore, if a server-side user ID with the information is received from the origin server 3c, the server-side user ID and a server name (of the origin server 3c) are stored in correspondence with the user ID in the session information memory 13 (S28). For example, it is assumed that a user of the user ID “AAA” requests information of the origin server 3c by indicating “URLc”. In this case, as shown in FIG. 10, the server name “cc” and the server-side user ID “cc2” assigned by the origin server 3c are stored in correspondence with the user ID “AAA” in the session information memory 13.

Next, the processing explanation is returned to S8 in FIG. 7. If the information corresponding to the URL in the request is already stored in the replication memory 15 (S8), the control unit 11 reads out the information from the replication memory 15 (S10), and sends the information to the information requesting terminal 1b through the communication unit 8 (S11). In addition to this processing, as shown in FIG. 11, the control unit 11 stores a history of the user requests of the user ID “AAA” to read out the information of which URL is “URLc” in the history memory 12.

As mentioned-above, at S7 in FIG. 7, the terminal 1b of the user not having his user ID receives a cookie including the user ID “AAA” from the intermediary server 2, and the terminal 1b stores the user ID. Hereinafter, when the terminal 1b sends an information readout request to the intermediary server 2, the user ID “AAA” is included as the cookie in the information readout request. In the intermediary server, when the information readout request is received from the terminal 1b, if the replication memory 15 does not store information indicated by a URL in the request, the control unit 11 retrieves the server-side user ID corresponding to the user ID in the request and desired origin server name from the session information memory 13, and sends the information readout request including the server-side user ID to the desired origin server.

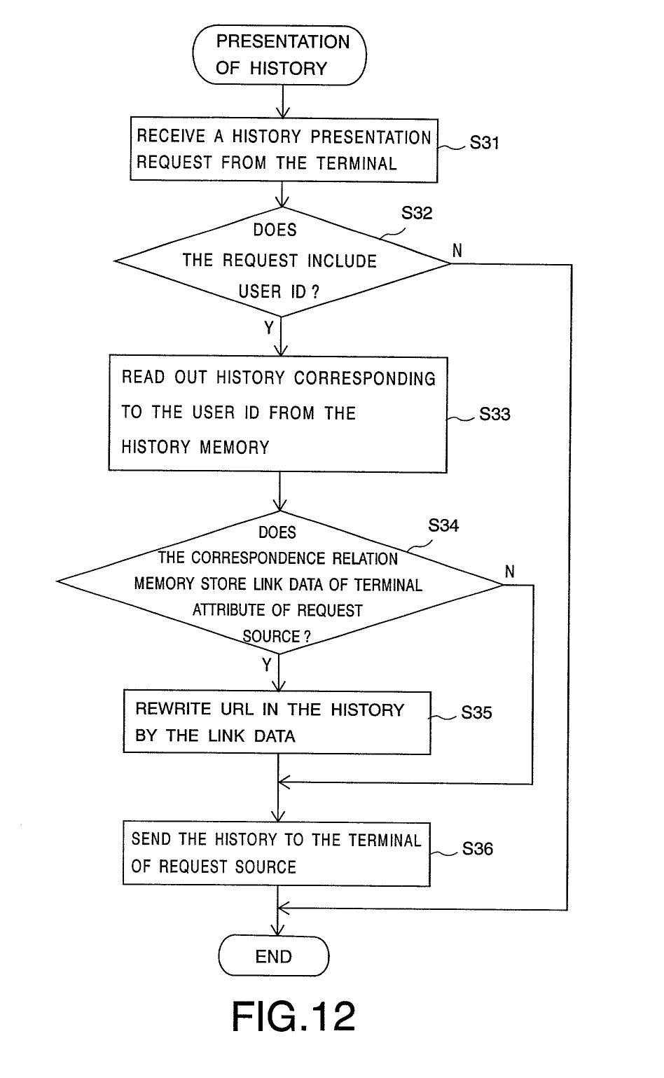

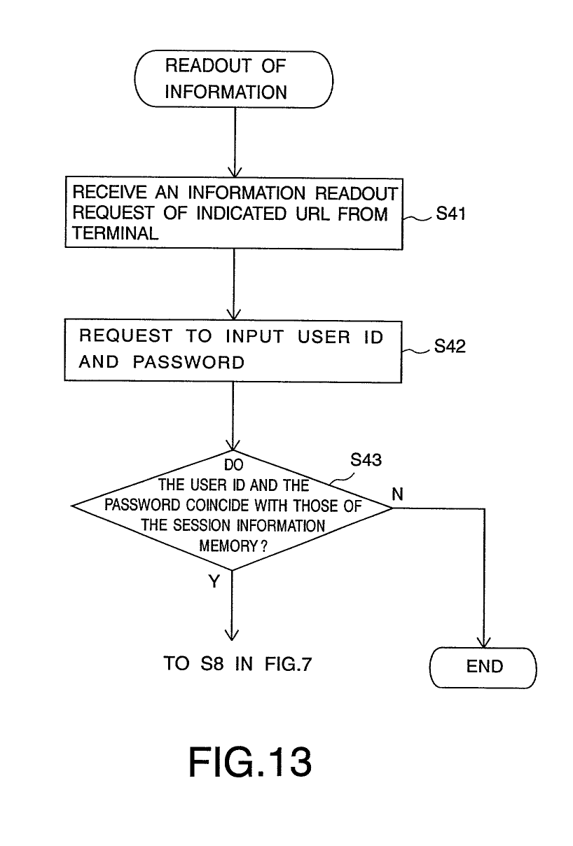

Next, a presentation processing of history stored in the history memory 12 is explained. FIG. 12 is a flow chart of the presentation processing of history. For example, it is assumed that a user having the user ID “AAA” inputs a history readout request through the terminal 1b. In this case, the user indicates a predetermined URL or inputs character strings not used for URL in order to directly send a history readout request to the intermediary server 2. This request may be the same format as shown in FIG. 6. In the intermediary server, when the history readout request is received (S31), the control unit 11 retrieves the history (URL group) corresponding to the user ID “AAA” in the request from the history memory 12 (S32, 33). For example, as shown in FIG. 11, URL group “URLa”, “URLb”, “URLc” are read out as the history of the user ID “AAA”. Next, the control unit 11 decides whether link data corresponding to terminal attribute of request source terminal and each URL in the history is stored in the correspondence relation memory 14 (S34). If the link data is stored in the correspondence relation memory 14, the control unit 11 replaces the URL in the history with the link data (S35). For example, as shown in FIG. 9, if the terminal attribute of the terminal 1b included in the history readout request is “attribute b”, “URLa” in the history is replaced by “URLab”, and “URLc” in the history is replaced by “URLcb”. After retrieval from the correspondence relation memory 14 and URL replacement of URL are executed for all URLs in the history, the processed history, i.e., “URLab”, “URLb”, “URLcb”, is sent to the terminal 1b (S36). In the terminal 1b, when the history is received from the intermediary server 2, the history is output through a display. The user selects his desired URL from the history on the display, and requests to read out information corresponding to the selected URL. In this case, the user can obtain the information suitable for attributes of the terminal 1b without consciousness of the attributes of the terminal 1b.

As mentioned-above, in the session information memory 13 of the intermediary server 2, for example, as for a user having the user ID “AAA” issued by the intermediary server, the user ID, the server name of the origin server to which the user has accessed in the past, and the server-side user ID of a terminal (1a or 1b) issued by the origin server when the user first utilizes the terminal to access to the origin server, are correspondingly stored. In the intermediary server 2, when the information readout request including the user ID is received from any terminal by the same user, if the requested information is not stored in the replication memory 15, the control unit 11 retrieves a server-side user ID corresponding to the user ID and an origin server name including requested information from the session information memory 13, and transfers the information readout request with the server-side user ID to the origin server. Accordingly, even if the same user accesses the origin server through a plurality of terminals, the origin server can discriminate the same user without special processing. Furthermore, this processing is executed in the intermediary server. Accordingly, operation burden of contents provider who manages the origin server greatly reduces.

In the history memory 12, for example, a history that a user of the user ID “AAA” requested to access to the origin server from the terminals 1a and 1b through the intermediary server is stored in correspondence with the user ID “AAA”. Accordingly, if only the user informs user ID “AAA” to the intermediary server through any terminal, the user can obtain his access history to WWW server from the terminal. By referring to the history, even if the user changes from one terminal to another terminal, the user's burden to input URL or to trace a link of information is greatly reduced.

Furthermore, the history to be provided from the intermediary server is previously rewritten by attribute of the terminal of history request source. In short, an original URL in the history is replaced by another URL suitable for attributes of the history requesting terminal. Accordingly, by referring to the history, the user can easily obtain information suitable for attributes of the terminal 1b without consciousness of the terminal attributes.

In order to realize the above-mentioned service as mediation business, traders of the mediation can obtain advertisement income by increase of page view as one function of portal. Furthermore, the traders can obtain price of additional value for contents of origin server side from contents provider.

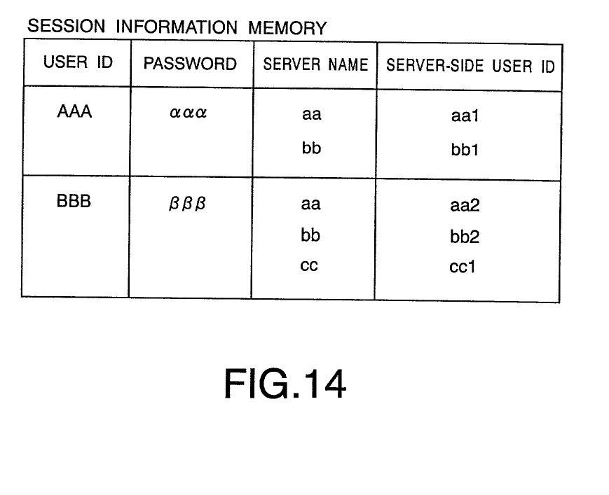

In the first embodiment, the information readout request from the terminal includes the user ID in a cookie. In the second embodiment, it is supposed that the intermediary server 2 is not the proxy server but the surrogate server. Accordingly, by using an authentication method in WWW system, a case of delivering the user ID is explained. As the authentication method in WWW system, various methods are utilized. As one example, “Basic Authentication” method is explained by referring to a flow chart shown in FIG. 13. In the “Basic Authentication” method, the user ID and a password of each user who can utilize the intermediary server 2 are previously stored in the session information memory 13 of the intermediary server 2 as shown in FIG. 14. When the information readout request is received from the terminal (S41), the intermediary server 2 requests the user to input the user ID and the password through the terminal (S42). In response to the user's input, the terminal sends the information readout request including the user ID and the password to the intermediary server 2 again. In the intermediary server 2, when the user ID and the password are received from the terminal, the control unit 11 respectively compares the user ID and the password with the registered ones in the session information memory 13 (S43). In case of coincidence, the processing is forwarded to S8 in FIG. 7 and following processing is the same as the first embodiment. In case of non-coincidence, the processing is completed.

As another authentication method in WWW system, a general method such as “SSL (Secure Socket Layer)”, “rewriting of URL”, or “Hidden Form” can be utilized.

In the second embodiment, even if the terminal does not correspond to the cookie or the terminal is set to reject the use of the cookie, the WWW system including the intermediary server and the terminal can correctly operate.

A memory can be used to store instructions for performing the function of the intermediary server described above, such a memory can be a CD-ROM, floppy disk, hard disk, magnetic tape, semiconductor memory, and so on.

As mentioned-above, in the present invention, even if one user accesses to an origin server from a plurality of terminals, the origin server can identify the one user. Furthermore, even if the user access the origin server from any terminal of the plurality of terminals, the user can view his access history from the plurality of terminals to the origin server. Furthermore, by referring to the access history, the user can easily access information suitable for the terminal attributes.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

[image]

[image]

[image]

[image]

[image]

[image]

[image]

[image]

[image]

[image]

[image]

[image]

[image]

[image]

[image]

[image]

[image]

[image]

What is claimed is:

1. An intermediary server apparatus which relays an information readout request from a terminal to an origin server, and relays information provided by the origin server to the terminal, comprising:
a memory configured to correspondingly store a first user ID to discriminate each user and a second user ID to discriminate each information readout request, the second user ID being assigned by the origin server to the user to identify the information readout request;
a communication unit configured to retrieve the second user ID in response to the first user ID from said memory in case of receiving the information readout request including the first user ID from the terminal, and to send the information readout request including the second user ID to the origin server.

2. The intermediary server apparatus according to claim 1,
wherein a plurality of origin servers each provide information in case of receiving the information readout request, and each origin server uniquely assigns the second user ID to the terminal.

3. The intermediary server apparatus according to claim 2,
wherein a plurality of terminals each input the first user ID from the user in case of sending the information readout request.

4. The intermediary server apparatus according to claim 1,
wherein said memory additionally stores a server name of the origin server which assigns the second user ID in correspondence with the first user ID and the second user ID.

5. The intermediary server apparatus according to claim 4,
further comprising a control unit configured to generate the first user ID if the information readout request does not include the first user ID and the first user ID is not input by the user through the terminal, and to send the first user ID to the terminal,
wherein said memory newly stores the first user ID.

6. The intermediary server apparatus according to claim 4,
wherein said communication unit sends the information readout request without the second user ID to the origin server if said memory does not store the second user ID corresponding to the first user ID.

7. The intermediary server apparatus according to claim 6,
wherein said memory newly stores the second user ID and the server name in correspondence with the first user ID, if the information provided by the origin server includes the second user ID.

8. The intermediary server apparatus according to claim 3,
further comprising a history memory configured to correspondingly store the first user ID and a history of information readout requests sent to the plurality of origin servers, the information readout requests being received with the first user ID from the terminal.

9. The intermediary server apparatus according to claim 8,
wherein said communication unit retrieves the history corresponding to the first user ID from said history memory in case of receiving a history presentation request including the first user ID from the terminal, and sends the history to the terminal.

10. The intermediary server apparatus according to claim 9,
further comprising a correspondence relation memory configured to correspondingly store an attribute of a terminal and link data for the terminal to read out information, if information provided by the origin server includes the attribute and the link data.

11. The intermediary server apparatus according to claim 10,
wherein said communication unit updates the history by referring to the link data, if said correspondence relation memory stores the link data corresponding to the attribute of the terminal, and sends the updated history to the terminal.

12. The intermediary server apparatus according to claim 4,
wherein said memory additionary stores a password in correspondence with the first user ID, the server name, and the second user ID, and
wherein said communication unit relays the information readout request from the terminal to the origin server, if a password of the first user ID input by the user through the terminal coincides with a password of the same first user ID stored in said memory.

13. An information providing method for relaying an information readout request from a terminal to an origin server, and for relaying information provided by the origin server to the terminal, comprising:
correspondingly storing a first user ID to discriminate each user and a second user ID to discriminate each information readout request in a memory, the second user ID being assigned by the origin server to the user to identify the information readout request;
retrieving the second user ID in response to the first user ID from the memory in case of receiving the information readout request including the first user ID from the terminal; and
sending the information readout request including the second user ID to the origin server.

14. The information providing method according to claim 13,
wherein a plurality of origin servers each provide information in case of receiving the information readout request, and each origin server uniquely assigns the second user ID to the terminal.

15. The information providing method according to claim 14,
wherein a plurality of terminals each input the first user ID from the user in case of sending the information readout request.

16. The information providing method according to claim 13,
further comprising:
additionally storing a server name of the origin server which assigns the second user ID in correspondence with the first user ID and the second user ID in the memory.

17. The information providing method according to claim 16,
further comprising:
generating the first user ID, if the information readout request does not include the first user ID and the first user ID is not input by the user through the terminal;
sending the first user ID to the terminal; and
newly storing the first user ID in the memory.

18. The information providing method according to claim 16,
further comprising:
sending the information readout request without the second user ID to the origin server if the memory does not store the second user ID corresponding to the first user ID.

19. The information providing method according to claim 16,
further comprising:
additionally storing a password in correspondence with the first user ID, the server name and the second user ID in the memory; and
relaying the information readout request from the terminal to the origin server, if a password of the first user ID input by the user through the terminal coincides with a password of the same first user ID stored in the memory.

20. A computer program product, comprising:
a computer readable program code embodied in said product for causing a computer to relay an information readout request from a terminal to an origin server, and to relay information provided by the origin server to the terminal, said computer readable program code having:
a first program code to correspondingly store a first user ID to discriminate each user and a second user ID to discriminate each information readout request in a memory, the second user ID being assigned by the origin server to the user to identify the information readout request;
a second program code to retrieve the second user ID in response to the first user ID from the memory in case of receiving the information readout request including the first user ID from the terminal; and
a third program code to send the information readout request including the second user ID to the origin server.
